(19) United States
(12) Patent Application Publication
(10) Pub. No.: US 2005/0257175 A1
(43) Pub. Date: Nov. 17, 2005

(54) Electronic communication interface

(76) Inventors: Amy J. Brisben, Baltimore, MD (US); Corinna E. Lathan, Wheaton, MD (US); Anna D. Lockerd, Washington, DC (US); Matthew E. Pettersen, Berwyn Heights, MD (US); Jack M. Vice, Washington, DC (US)

Correspondence Address: LIEBERMAN & BRANDSDORFER, LLC, 12221 MCDONALD CHAPEL DRIVE, GAITHERSBURG, MD, 20878, US

(21) Appl. No.: 11/125,460

(22) Filed: May 10, 2005

Related U.S. Application Data
(60) Provisional application No. 60/570,956, filed on May 13, 2004.

(51) Int. Cl. G06F 17/00; G06F 9/00; G06F 13/38; G06F 13/12; G06F 3/00; G09G 5/00

(52) U.S. Cl. 715/865; 345/156

(57) ABSTRACT

A multi modal communication interface is provided. The interface enables persons with physical or cognitive disabilities to interface with a computing device. The interface provides a plurality of input sensors, input ports for receiving additional input sensors, and logic to enable an additional input sensor to communicate with the interface and the computing device. A serial hub is provided to communicate a signal received from an actuated sensor via a controller in communication with the sensor to an embedded processor in communication with the serial hub.

### CROSS REFERENCE TO RELATED APPLICATION(S)

This is a non-provisional utility patent application claiming benefit of the filing date of U.S. provisional application Ser. No. 60/570,956 filed May 13, 2004, and titled MISSION CONTROL.

### BACKGROUND OF THE INVENTION

1. Technical Field

This invention relates to a communication interface. More specifically, the invention relates to an interface to facilitate translations of human communication with a computer or computer based system.

2. Description Of The Prior Art

Use of personal computers in the home and the office has become commonplace. Schools today provide classes on computers for students starting in kindergarten and continuing through high-school. However, for older persons who have not been exposed to technology from a young age and educated on how to operate a computer, the use of a computer can be a challenging task. Similarly, for people with physical and/or cognitive disabilities operating a personal computer can be challenging as well. Sometimes the difficulties faced while operating a personal computer are physical, wherein the person operating the computer cannot readily manipulate an input device such as a keyboard, mouse, and/or trackball. Some persons with disabilities may be capable of operating alternative analog input devices, while others may only be capable of operating simple binary input devices. In cases of extreme physical impairment, an auditory input device may be the only accessible means of control.

There are commercially available hardware accessories for persons with physical disabilities associated with use of electronic devices such as a computer. For example, AbleNet, Inc. has designed a variety of binary switches, which provide accessible form factors for interfacing with electronic devices. These switches require an interface and associated software to enable communication with the processor of a personal computer. Accordingly, although AbleNet switches accommodate persons with physical disabilities, the accommodation is only made available subsequent to completing a non-rudimentary installation procedure.

Another solution that provides an input device for people with disabilities is a switch box provided by Crick Software. The switch box can accommodate four binary input devices such as AbleNet switches, allowing them to interface with a computer via serial connection. However, the switch box is limited to binary input devices, as it does not include auditory or analog input ports. In addition, not only does the switch box not have physical ports to receive an analog input device, it does not have software to enable the computer to which the box communicates to recognize an analog input device.

There is therefore a need for a multi-modal interface that accommodates binary and analog input devices, as well as an auditory input device. The multi-modal interface should include software that can communicate with a personal computer without additional programming requirements for the person using the computer. The interface should read the input device type and enable the computer to recognize the input device without requiring any additional software support.

### SUMMARY OF THE INVENTION

This invention comprises a multi-modal interface adapted to function as a communication interface.

In one aspect of the invention, a communication interface is provided with a proportional activator and a binary input port that is configured to receive a binary input device. A serial communication is provided to be received by a serial port of a computing device, and a primary controller is provided to communicate a signal received from one of the devices to the serial connector. The devices include the proportional activator and/or the binary input device. Each of the proportional activator, the binary input port, and the primary controller are mounted on a single modular platform.

In another aspect of the invention, a communication interface is provided with a proportional activator device, a binary input port to receive a binary input device. A serial communication is provided to be received by a serial port of a computing device, and a primary controller is provided to communicate a signal received from one of the devices to the serial connector. In addition, an analog input port is provided and configured to receive an analog input device. When an analog input device is connected to the analog input port, the connection changes the functionality of the proportional activator from a proportional activator to a binary activator. A serial communication is provided to be received by a serial port of a computing device, and a primary controller is provided to communicate a signal received from one of the devices to the serial connector. The devices include the proportional activator and/or the binary input device.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a perspective view of the interface.

FIG. 2 is a cross section of an elevational view of the proportional activator;

FIG. 3 is a block diagram of one embodiment of the communication interface;

FIG. 4 is a block diagram of the interface without a feedback controller;

FIG. 5 is a block diagram showing uni-directional flow of communication between the interface and a computing device; and

FIG. 6 is a block diagram showing bi-directional flow of communication between the interface and a computing device.

### DESCRIPTION OF THE PREFERRED EMBODIMENT

### Technical Details

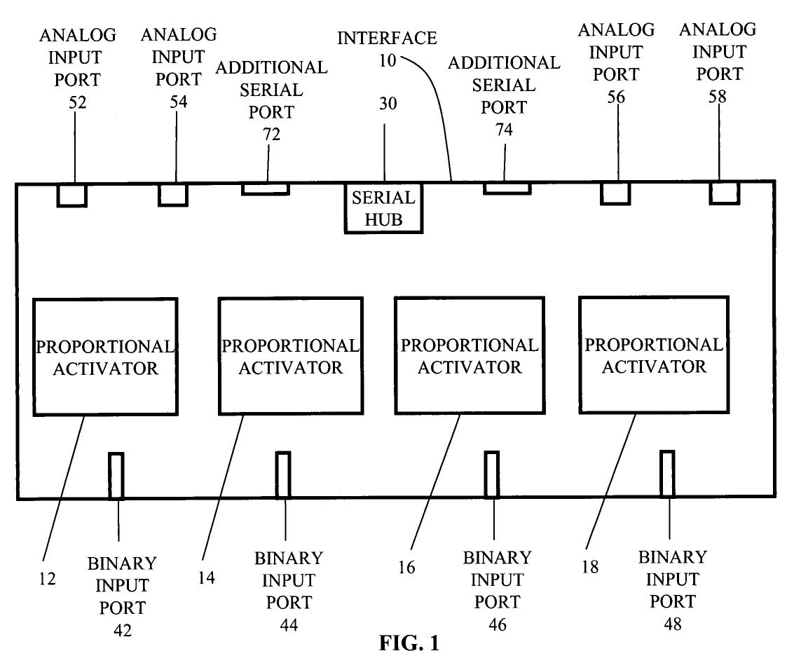

Referring to FIG. 1, an external perspective view of a communication interface 10 is shown. The elements of the interface 10 shown in this view include proportional activators 12, 14, 16, 18, binary input ports 42, 44, 46 and 48, analog input ports 52, 54, 56, and 58, serial ports 72 and 74, and a serial hub 30. The binary input ports 42, 44, 46, and 48 are each configured to receive an input device to convey received data in a binary form. Similarly, each of the proportional activators receives data associated with motion of the activator and communicates analog data generated from the motion to an associated controller. Data from each of the proportional activators and data generated from devices in communication with the binary, analog, and/or input ports is communicated to the serial hub 30. Accordingly, the communication interface 10 is a platform tool for communicating data to a computing device in communication therewith.

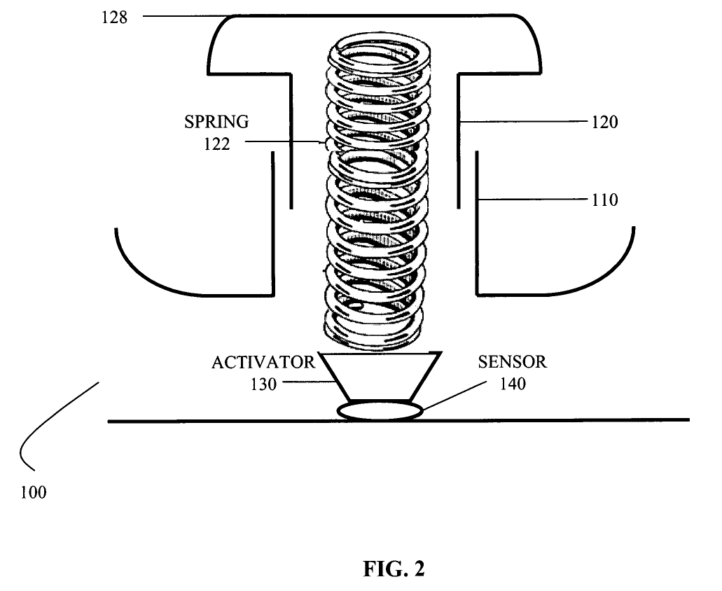

As shown in FIG. 1, the communication interface includes a plurality of proportional activators. FIG. 2 is an elevational view of one embodiment of the activator 100 in an extended position, i.e. no force has been applied to the activator. The activator includes a surface activation area 128 and an interior cylinder 120. In one embodiment, the surface activation area 128 may be a top exterior surface. The interface has a cylindrical cavity 110 sized to receive an interior cylinder 120. The interior cylinder 120 contains a spring 122 to translate application of force applied to the surface activation area 128. As force is applied to the surface activation area 128, the spring 122 compresses, which activates a sensor 140 through an activator 130 mounted between a bottom portion of the spring 122 and the sensor 140. Force applied to the sensor 140 is a function of the constant of the spring. The sensor 140 is a proportional sensor configured to provide a linear range of values proportional to the force exerted from the surface activation area 128 through the spring 122. In one embodiment, the proportional sensor 140 may be a variable resistor. The range of values of the sensor may vary depending upon the bit resolution associated with the sensor. For example, a three bit resolution can provide up to 8 linear values. Accordingly, the proportional activator is a tool used to communicate a degree of force applied to an activator into discrete linear values.

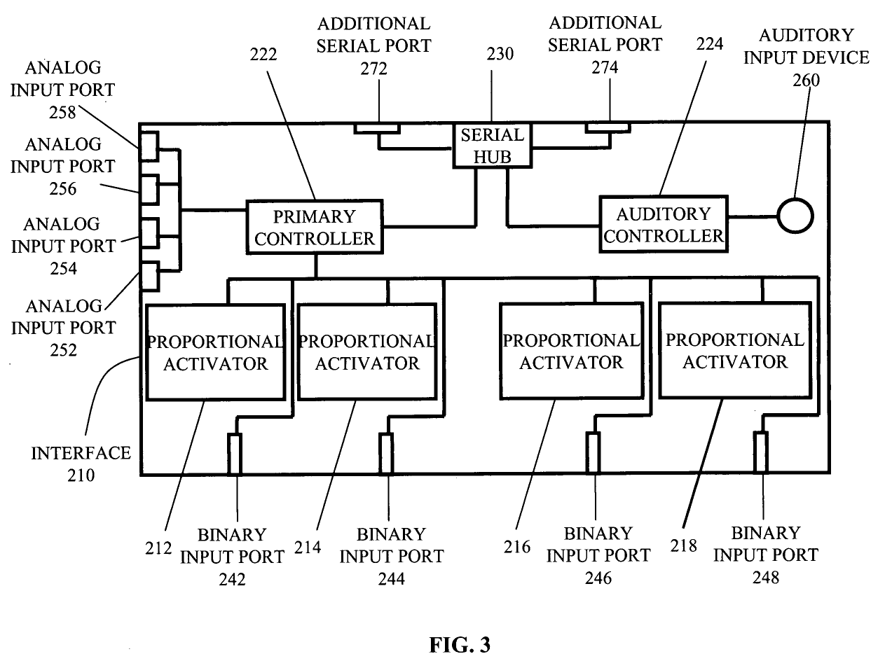

FIG. 3 is a planar view of the communication interface 200 showing the connection of each of the components therein. There are four proportional activators 212, 214, 216, and 218. Each of the activators is electrically connected to a primary controller 222, which is in electrical communication with a serial hub 230. The primary controller 222 supports analog to digital conversion of data from the proportional activators to a serial stream of data. Following the analog to digital conversion of data received from the proportional activator, the primary controller 222 communicates signals received from each of the associated proportional activators to the serial hub 230, where serial data streams from the controller are combined for communication to a computing device (not shown). In addition to the proportional activators, the interface includes binary input ports 242, 244, 246, and 248, and analog input ports 252, 254, 256, and 258. Each of the binary input ports is configured to receive a binary input device. As shown, each of the binary ports and analog input ports are in communication with the primary controller 222. Similar to the proportional activators, data received from a binary input device through the associated binary input port are communicated to the primary controller 222 for analog to digital conversion prior to communicating the data to the serial hub 230. The purpose of the analog input ports is similar to that of the binary input port in that they enable connection of an external analog input device to the interface 200. Connection of an auxiliary analog input device will enable the input from the auxiliary proportional sensor to be communicated to the embedded processor through the serial connection of the serial hub 230 without additional software or hardware support. Similarly, data received from an analog input device through the associated analog input port is communicated to the primary controller 222 for analog to digital conversion prior to communicating the data to the serial hub 230. The communication interface may also include additional serial ports 272 and 274. Each of these serial ports 272 and 274 are configured to receive a serial input device. Data received from a serial input device is directly communicated to the serial hub 230 as data received from the serial input device does not require any conversion. Additionally, in one embodiment an auditory input device 260 may be included with an auditory controller 224 to process and communicate auditory data to the serial hub 230. The auditory input device 260 may be in the form of a microphone. The hub 230 receives and translates data acquired from the primary controller 222 and/or the auditory controller 224 and communicates the translated data to an embedded processor (not shown) in an associated computing device. The combination of the primary controller 222, the auditory controller 224, and the hub 230 enables data from the proportional activators 212, 214, 216, 218 to be communicated to the embedded processor without the need for any additional hardware or software support. Accordingly, the interface serves as a communication platform using proportional activators, binary input devices, and/or analog input devices.

The proportional activators 212, 214, 216, 218 may be visually distinguishable to the operator. For example, in a preferred embodiment, each of the activators is a different color that is clearly distinguishable. It may be that each of the activators is a different color, or that at least one of the activators is the same color as another activator, depending on the purpose of an exercise associated with the interface.

An auxiliary binary input device may come in the form of a switch, such as a momentary, pushbutton, rocker, toggle, snap, rotary, or other input device having two possible values. There are a variety of reasons that an operator may select to use an auxiliary input device in place of one or more of the proportional activators. Particularly in the disability community, some users may only be capable of activating a specific type of switch. If the interface is being used for therapeutic purposes, a different type of input device may require an operator to utilize different muscles to activate the auxiliary input device. It may also be desirable, in a therapeutic setting, to use a specific type of sensor in order to target specific muscles for activation. In addition, depending upon the apparatus with which the interface 200 is communicating, different types of binary input sensors may be required to enable proper communication.

In one embodiment, when an auxiliary analog input device is connected to one of the analog input ports, the connection may alter the functionality of the proportional activators, changing the proportional activator to a binary activator. For example, connection of an auxiliary analog input device into analog input port 252 will, for the duration of the connection, change the functionality of corresponding activator 212 from proportional to binary. An auxiliary analog input device may come in the form of a variable resistor activated by pressure, force, bend, rotation, slide, or other, a joystick, or any other device that measures velocity, acceleration, temperature, or other physical phenomenon, capable of conveying up to 65536 discrete, linear values via serial connection at 16 bit resolution. For example, a two bit resolution is capable of conveying up to four discrete linear values, and a three bit resolution is capable of conveying up to eight discrete linear values. The maximum quantity of linear values is related to the resolution, i.e. bandwidth, of the serial connection. The relationship between bit resolution and linear values is 2ⁿ, where n represents the bit resolution and the product is the maximum quantity of linear values. There are a variety of reasons that an operator may select an auxiliary analog input device in place of one or more of the binary input devices. If the interface is being used for therapeutic purposes, a different type of input device may require an operator to utilize different muscles to activate the auxiliary input device. In addition, depending upon the apparatus with which the interface 10 is communicating, different types of binary input sensors may be required to enable proper communication.

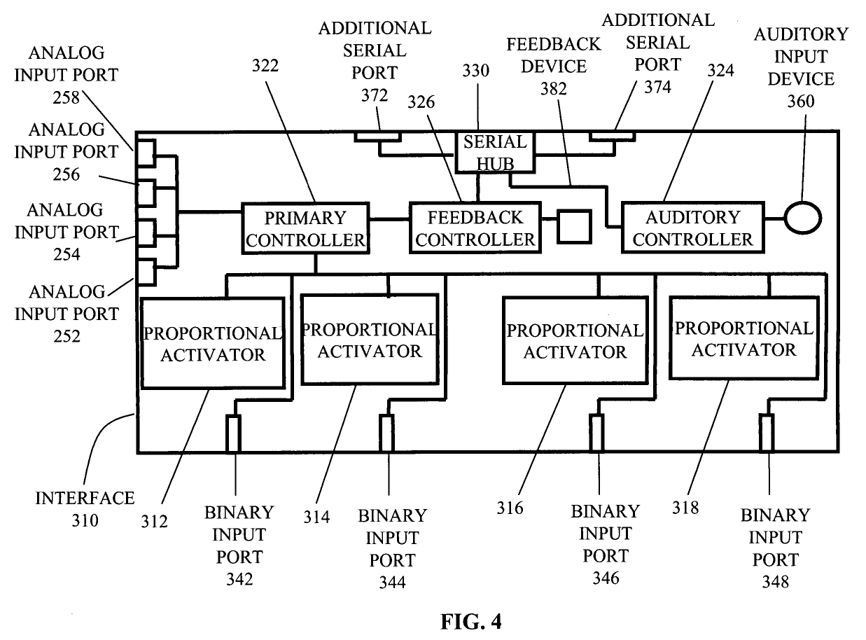

The communication interface in FIG. 3 is limited to communicating data from an input device to a computing device via the primary controller and serial connection. However, the interface may also support feedback communication in the form of visual, tactile, and auditory formats. FIG. 4 is a planar view of the communication interface 300 showing a feedback controller that supports feedback communication. As shown data received by a primary controller 322 is forwarded to the serial hub 330 as well as a feedback controller 326, which communicates the data to a feedback device 382. Data communicated to the feedback device may be in visual, tactile, or auditory form. For example, in one embodiment the feedback device may be an LED or an array of LEDs that illuminate in response to the data received. In the case of an array of LEDs, the quantity of LEDs that illuminate may be proportional to the data received from an input device. Similarly, an auditory feedback device may have different audio responses and/or commands mapped according to the data received from an input device. Such audio responses may vary in volume or pitch in relation to data received from the input device. Each potential feedback device 382 may be configured to respond in a binary or proportional format based upon mapping instructions received from the feedback controller. Accordingly, the implementation of the feedback controller enables a person activating an input device to a receive feedback response corresponding to the data received by the input device.

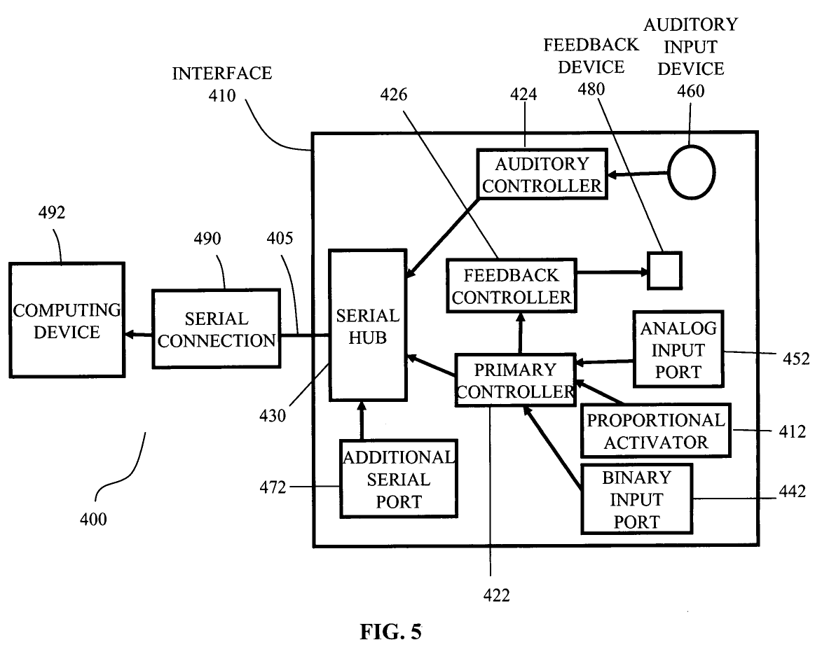

FIG. 5 is a block diagram 400 illustrating the flow of communication and data among the elements of the communication interface. As shown, the block diagram includes all of the elements of FIG. 4 with each numbered element corresponding to those identified in FIG. 4 except each of the elements is designated with a 400 series number assignment. The primary controller 422 receives data communication from one or more of the binary input ports 442-448, one or more of the proportional activators 412-418, and one or more of the analog input ports 452-458. In addition, an auditory device controller 424 is provided to receive auditory data from an auditory input device 460. In one embodiment, the auditory device may be a microphone. Both the primary controller 422 and the auditory controller 424 perform analog to digital conversion for all non-digital data received from the various input devices. Data from the primary controller 422 and the auditory controller 424 is forwarded to both the serial hub 430 and the feedback controller 426. In one embodiment, the interface may include one or more of the additional serial ports 472 and 474 in communication with the serial hub 430. Data from an input device in communication with one of the additional serial ports does not require conversion. Upon receipt of data from the primary, the auditory controller, and/or an input device in communication with one of the additional serial ports, the serial hub 430 combines the received data and forwards the data to a computing device 492 through a serial connection 490. As shown at 405, the serial hub has a unidirectional relationship with the interface 410 in that data flows from the hub 430 to the computing device. In this embodiment, the hub 430 is not configured to receive data from the serial connection 490. Accordingly, in addition to the feedback controller, two controllers are provided to process data received from various input devices and to communicate the processed data to a serial hub for unidirectional transmission to a computing device.

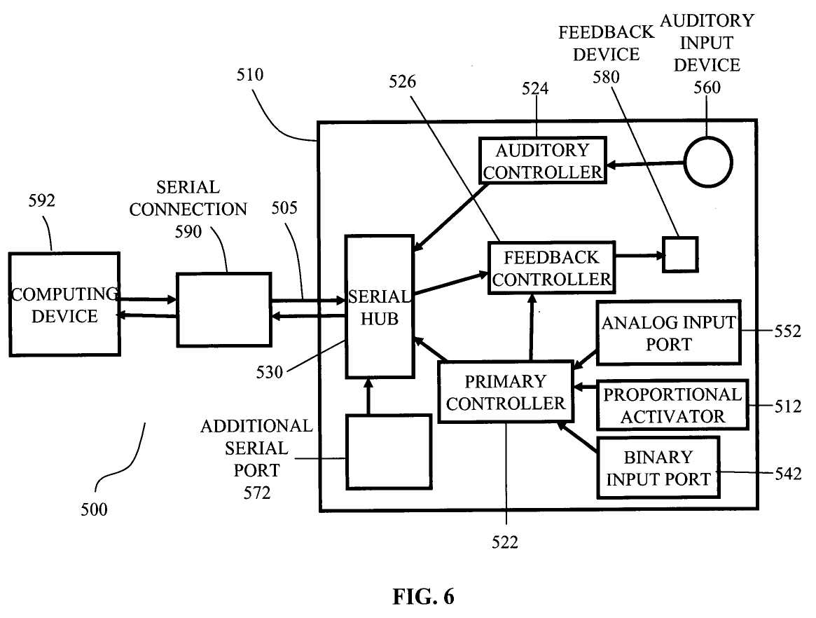

FIG. 6 is a block diagram 500 illustrating the flow of communication and data among the elements of the communication interface. As shown, the block diagram includes all of the elements of FIG. 5 with each numbered element corresponding to those identified in FIG. 5 except each of the elements is designated with a 500 series number assignment. The primary controller 522 receives data communication from one or more of the binary input ports 542-548, one or more of the proportional activators 512-518, and one or more of the analog input port 552-558. In addition, an auditory controller 524 is provided to receive data from an auditory input device. In one embodiment, the auditory device may be a microphone. Both the primary controller 522 and the auditory controller 524 perform analog to digital conversion for all non-digital data received from the various input devices. Data from the primary controller 522 and the auditory controller 524 is forwarded to both the serial hub 530 and the feedback controller 526. In one embodiment, the interface 510 may include one or more of the additional serial ports 572 and 574 in communication with the serial hub 530. Data from an input device in communication with one of the additional serial ports does not require conversion. Upon receipt of data from the primary controller, the auditory controller, and/or an input device in communication with one of the additional serial ports, the serial hub 530 combines the received data, and forwards the data to a computing device 592 through a serial connection 590. As shown at 505, the serial hub support bidirectional communication flow with the computing device 592. Data flows from the serial hub 530 to the computing device 592, and data also flows from the computing device 592 to the serial hub 530. The data received from the computing device 592 is received by the serial hub 530 and forwarded to the feedback device 580 from the feedback controller 526. Data communicated to the feedback device 580 from either the primary controller 522 or the serial hub 530, may be in visual, tactile, or auditory form. For example, in one embodiment the feedback device may be an LED or an array of LEDs that illuminate in response to the data received. In the case of an array of LEDs, the quantity of LEDs that illuminate may be proportional to the data received from an input device. Similarly, an auditory feedback device may have different audio responses and/or commands mapped according to the data received from the input device. Such responses or commands may vary in volume or pitch in relation to data received from the input device. Each potential feedback device 580 may be configured to respond in a binary or proportional format based upon mapping instructions received from the feedback controller. Accordingly, bidirectional communication between the serial hub 530 and the computing device 592 is supported.

### Advantages over the Prior Art

The interface is a multi-modal communication interface adapted for use with children and adults with physical and/or cognitive disabilities, as well as any persons who are unable to interact with a computing device using the standard keyboard and mouse interfaces. The interface includes proportional activators, and optional binary and analog input ports adapted to receive binary and analog input devices, respectively. Each input port has a female plug adapted to receive a male plug of an associated input device. The interface includes a serial plug that is adapted to be received by a serial port of a computing device. The interface contains specific electronics and is preprogrammed with software that enables inputs received by any of the input devices to be communicated to a computing device connected to the communication interface. In addition to offering proportional control of a computing device in an accessible form factor, the interface also includes expansion options, allowing users to also interact with the computing device via binary inputs, auditory inputs, and auxiliary serial devices, including wireless communications devices.

### Alternative Embodiments

It will be appreciated that, although specific embodiments of the invention have been described herein for purposes of illustration, various modifications may be made without departing from the spirit and scope of the invention. In particular, the connection between the communication interface and a computer may be through a wired connection or through a wireless connection that supports serial communication of data therebetween.

In addition, although the interface is shown with a set quantity of proportional activators and input ports, the quantity of each may be varied depending upon the communication requirements. For example, in one version the interface may be limited to two binary input ports, and it may or may not include an auditory input device such as 460. In one embodiment, the auditory device may be a microphone to receive and convey auditory data. In addition, the proportional activator may be in the form shown in FIG. 2, or it may be substituted for a proportional input device that utilizes an electromechanical encoder that conveys linear motion in the vertical plane. Other elements that may be incorporated into the interface include a camera or other input devices, as well as light emitting diodes (LEDs), or other audio, visual, or tactile feedback devices. The camera is preferably used for telecommunication of movement(s) of the operator in response to interaction with a program in communication with the interface. The camera is utilized to transmit images to a viewer at a remote location. When the interface is employed in tele-therapy, the camera may be used to transmit images to a therapist at a remote location. The images enable the therapist to view posture, facial expressions, and many other visual images. The camera enables the therapist to visually analyze an operator's response that may not be otherwise available through alternative binary or analog input to the interface. Accordingly, the scope of protection of this invention is limited only by the following claims and their equivalents.

1. A communication interface comprising:
a proportional activator;
a binary input port adapted to receive a binary input device;
a serial connector adapted to be received by a serial port of a computing device;
a primary controller adapted to communicate a signal received from a device to said serial connector, wherein said device is selected from a group consisting of: said proportional activator, said binary input device, and combinations thereof; and
said proportional activator, said binary input port, said serial connector, and said primary controller are mounted on a single modular unit.

2. The interface of claim 1, wherein said proportional activator includes an electromechanical linear encoder adapted to communicate with a binary circuit responsive to linear displacement of said activator, to convey a plurality of discrete linear values reflective of said displacement through a serial connection, wherein a maximum quantity of said linear values is proportional to a bandwidth of said serial connection.

3. The interface of claim 2, wherein said proportional activator indirectly communicates with a feedback device and output from said feedback device is responsive to linear displacement of said activator.

4. The interface of claim 1, wherein said proportional activator includes a force sensitive resistor and a spring, whereby linear motion of said activator in a vertical plane compresses said spring and applies force to said resistor to convey a plurality of discrete linear values reflective of said force through a serial connection, wherein a maximum quantity of said linear values is proportional to a bandwidth of said serial connection.

5. The interface of claim 4, wherein said proportional activator indirectly communicates with a feedback device and output from said feedback device is responsive to activation of said force sensitive resistor.

6. The interface of claim 1, further comprising an analog input port configured to receive an analog input device.

7. The interface of claim 6, wherein said analog input device is selected from a group consisting of: a variable resistor, any device activated by pressure, force, bend, rotation, and slide, and any device that measures velocity, acceleration, temperature, and physical phenomena, having a plurality of values.

8. The interface of claim 6, wherein connection of said analog input device to said analog input port changes said proportional activator to a binary activator.

9. The interface of claim 1, further comprising a serial hub configured to combine serial data streams.

10. The interface of claim 1, further comprising an auditory input device adapted to communicate an audio signal to a local controller to convert said signal to a serial stream.

11. The interface of claim 1, wherein said serial connector is wireless.

12. The interface of claim 1, further comprising a feedback controller in communication with said primary controller, wherein said feedback controller is adapted to convey a signal to control a device adapted to convey data in a form selected from a group consisting of: visual, tactile, and auditory.

13. The interface of claim 12, wherein data communicated to said feedback controller is received from a device selected from a group consisting of: a computing device in communication with said serial connector, and said primary controller.

14. A communication interface comprising:
a proportional activator device;
a binary input port adapted to receive a binary input device;
a serial connector adapted to be received by a serial port of a computing device;
an analog input port configured to receive an analog input device, wherein when an input device is connected to said analog input port said connection changes functionality of said proportional activator from a proportional activator to a binary activator; and
a controller adapted to communicate a signal received from said device to said serial connector, wherein said device is selected from a group consisting of: said proportional activator, said binary input device, said analog input device, and combinations thereof.
